(19) United States
(12) Patent Application Publication
(10) Pub. No.: US 2005/0046971 A1
(43) Pub. Date: Mar. 3, 2005

(54) Integrated lens assembly

(75) Inventors: Kah-Ong Tan, Shanghai (TW); Peter Tao, Shanghai (TW); Hui Wang, Shanghai (TW); Dong-Jin Zhang, Shanghai (TW)

Correspondence Address: Mr. Peter F. Corless;EDWARDS & ANGELL, LLP, 101 Federal Street, Boston, MA, 02110, US

(73) Assignee: Inventec Micro-Electronics Corporation

(21) Appl. No.: 10/651,507

(22) Filed: Aug. 29, 2003

(51) Int. Cl. G02B 7/02

(52) U.S. Cl. 359/811

(57) ABSTRACT

An integrated lens assembly is provided, including: 1) a casing having an opening; 2) a lens having a forward end received in the opening of the casing; 3) a lens protection device embedded in the casing via the opening to encapsulate the forward end of the lens, wherein the lens protection device partially protrudes from the casing; 4) an image processing unit optically connected to the lens for electrically acquiring images; 5) and a power source electrically connected to the image processing unit to supply power to the image processing unit for operating the image processing unit. The forward end of the lens can be flush or protrude from with the casing. The above integrated lens assembly reduces a prior-art gap between the lens and the lens protection device, thereby facilitating miniaturization of the integrated lens assembly.

### BACKGROUND OF THE INVENTION

1. Field of the Invention

The present invention relates to integrated lens assemblies having casings of reduced thickness, and more particularly, to an integrated lens assembly having photography function, such as a cell phone, a personal digital assistant (PDA), or a laptop, which can effectively reduce the gap for accommodating the lens and its protective member.

2. Description of the Related Art

With the rapid development of the electronic technology, the performance of electronic products have been effectively improved and escalated. To posses multifunction capability, most electronic products commonly used today, such as cell phones, PDAs (personal digital assistants), and notebook computers, are often provided with powerful communication features and increased memory capacities. In addition, it is essential to include an integrated lens assembly with image pickup function, allowing the user to take photos anywhere at will.

However, the desire to integrate more functions into the electronic product also necessitates larger configuration space to accommodate the required components therein. This limitation fails to satisfy consumers' increasing demand, favoring more compact size and lightweight structure for electronic products.

Therefore, there is a need to effectively reduce gaps between components to achieve optimal usage, which constitutes an important issue to the manufacturers of electronic products.

FIG. 1 illustrates a conventional integrated lens assembly installed in an electronic product, which includes a casing 1′ and a lens 20′ mounted therein. A lens protection device 21′ serves as a dust protector, wherein a transparent lid is mounted on the casing 1′ to align with the lens 20, forming a gap A between the lens 20′ and the lens protection device 21′ as a consequence of the design.

A conventional integrated lens assembly of such a configuration has at least the following disadvantages. First, mounting the lens protection device 21′ on the casing 1′ will increase the assembly cost for the casing. Second, the integrated lens assembly is usually mounted inside the electronic product in a manner to space it apart from the casing 1′ for accommodating the lens 20′, which can vary in size or shape for adjusting the focus of the integrated lens assembly, making it difficult to reduce the size of the electronic product due to the configuration of the integrated lens assembly. In addition, the lens protection device 21′ mounted on the casing 1′ further restricts the design flexibility and appearance of the electronic product by obstructing the outer surface.

Consequently, efforts have been made and are underway to solve the foregoing disadvantages to develop an electronic product having reduced thickness while providing multifunction capacity.

### SUMMARY OF THE INVENTION

It is therefore an objective of the invention to provide an integrated lens assembly for electronic product, which can reduce the gap between a lens of the integrated lens assembly and the casing of the electronic products to thereby effectively reduce the overall thickness of the electronic products.

It is another objective of the invention to provide an integrated lens assembly that is mounted inside an electronic product with a minimal gap, such that the thickness of the electronic product can be significantly reduced, allowing the design of the lens protection device for the integrated lens assembly to vary to meet the requirements of the aesthetic aspects, as well as achieve a slim profile of the electronic product.

In order to achieve the above and other objectives, the integrated lens assembly of the invention is suitable for use in an electronic product having a photography function. The integrated lens assembly includes: 1) an opening formed in the casing of the product using the invention; 2) a lens having an end penetrating the opening in the casing of the electronic product; 3) a lens protection device embedded into the opening of the casing to fully encapsulate the end of the lens, wherein the lens protection device may partially protrude from the casing; 4) an image processing unit optically connected to the lens for electrically acquiring the image pickup; 5) a power source electrically connected to the image processing unit to supply power to the image processing unit for operating the image processing unit.

The lens protection device can directly encapsulate the forward end of the lens to reduce the gap between the forward end of the lens and an interior surface of the casing. The exterior surface of the lens protection device can be made to either align with or protrude from the exterior surface of the electronic product according to the requirements. As such, the overall thickness of the electronic product incorporating an imaging function can be minimized.

Furthermore, the appearance of the lens protection device may be varied in color or pattern to match with the style and aesthetic design of the electronic product.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief description of the drawings is as follows:

FIG. 1 (PRIOR ART) is a cross-sectional view showing the configuration of the lens and casing of a conventional integrated lens assembly;

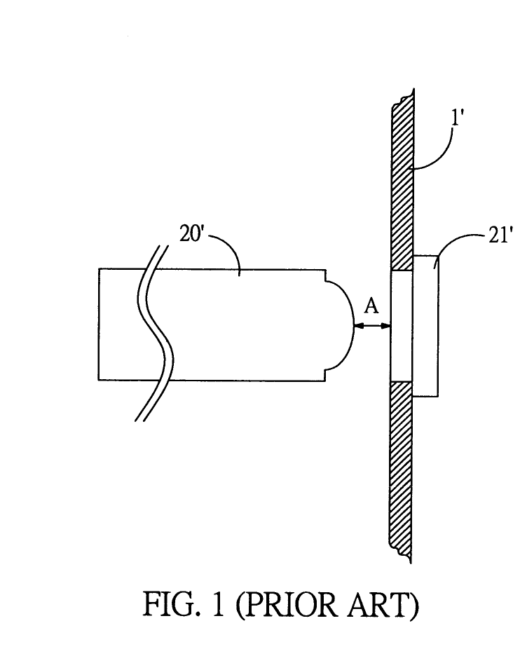

FIG. 2 is a perspective view of a cell phone having reduced thickness made possible by utilizing an integrated lens assembly according to one embodiment of the invention;

FIG. 3 is a cross-sectional view illustrating an integrated lens assembly having a lens assembled in a casing of an electronic product according to one embodiment of the invention; and

FIG. 4 is a perspective view of a cell phone having reduced thickness made possible by utilizing an integrated lens assembly on its rear side according to one embodiment of the invention.

### DETAILED DESCRIPTION OF THE PREFERRED EMBODIMENTS

Wherever possible in the following description, like reference numerals will refer to like elements and parts unless otherwise stated.

Although the invention is illustrated in reference to the following embodiments and the accompanying drawings to make those skilled in the art to realize the invention, it should be understood that those skilled in the art may practice the invention in various ways through modifications without departing from the scope and spirit of the invention.

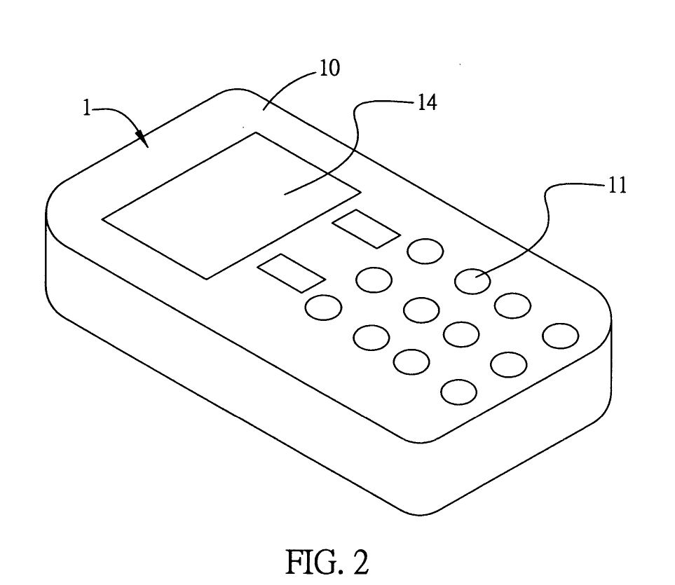

FIG. 2 illustrates a cell phone with a reduced assembly thickness by utilizing an integrated lens assembly according to one embodiment of the invention. It is noted that the integrated lens assembly is also applicable to other electronic products, such as PDA, notebook computer, and so on.

Referring to FIG. 2, a cell phone 1 comprises a casing 10 having a control circuit module (not shown) accommodated therein. A control panel is mounted on the front side of the casing 10 facing the user. The control panel at least includes a display unit 14, such as a liquid crystal display (LCD), and a set of control keys 11 for the user to input control signals for operating the cell phone. An integrated lens assembly, which is described in detail hereafter, is mounted on the other end of the casing 10.

When image acquisition is driven by inputting the control keys 11 to perform image pickup, the control circuit module inside the casing 10 drives the image acquisition module to acquire an image, and then drives the display unit 14 to display the acquired image. The control circuit module at least includes an image processing unit (not shown) and a power source (not shown). The image processing unit is optically connected to the integrated lens assembly for electronically obtaining the image taken by the integrated lens assembly. The power source supplies power to the image processing unit.

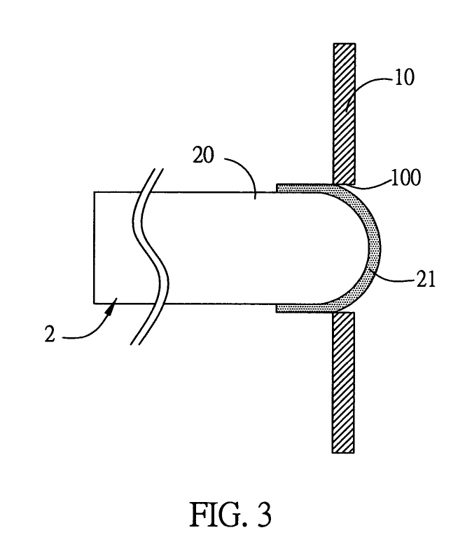

FIG. 3 is a cross-sectional view illustrating an integrated lens assembly 2 having a lens 20 assembled in a casing 10 according to one embodiment of the invention. For the sake of brief description, a cell phone 1 is schematically illustrated and other components thereof irrelevant to this invention are omitted herein.

As shown in FIG. 3, the casing 10 has an opening 100 for accommodating a U-shaped lens protection device 21 therein, wherein the lens protection device is a lid structure in a U shape made of materials such as transparent plastics or glass. The U-shaped lens protection device 21 accommodates the forward end of the lens 20 therein and serves as a dust protector and impact shield.

By structure the U-shaped lens protection device 21 can protrude out of the casing 10 via the opening 100 or align flush with the opening 100 depending on the requirements. Thereby, the portion of the lens 20 inside the U-shaped lens protection device 21 may be designed to protrude from the casing 10 via the opening 100 or align flush with the opening 100 according to user's requirement. Since the lens protection device 21 of the integrated lens assembly 2 can fully encapsulate the lens 20, the gap between the lens and the casing 10 is significantly reduced, allowing the thickness of the cell phone 1 assembled with the integrated lens assembly to be effectively reduced.

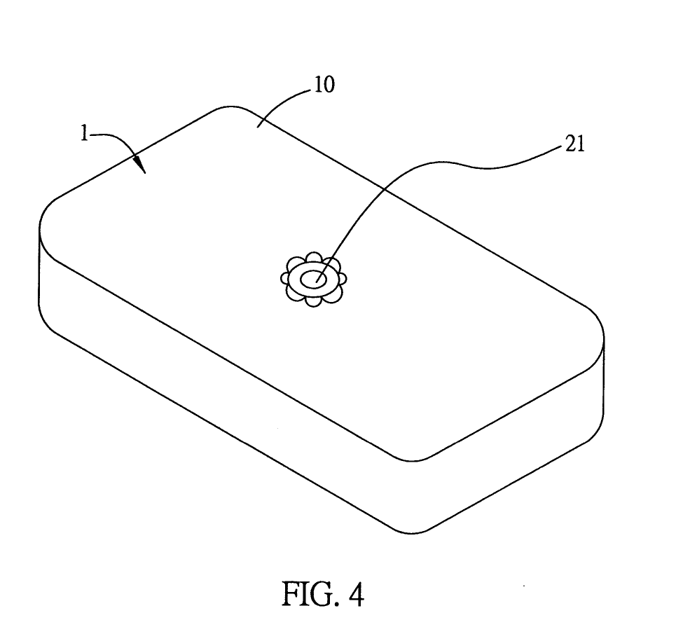

Furthermore, the aspect of the lens protection device 21 can be varied in color or pattern to match with the style and aesthetic design of the cell phone 1. FIG. 4 is a perspective view taken from a rear side of a cell phone assembled with an integrated lens assembly 2 having a lens 20. Referring to FIG. 4, the portion of the casing near the opening where the lens is inserted is formed in the pattern of flower-shape, thereby the lens protection device is camouflaged as a flower stamen to enhance or improve aesthetics. It is to be noted that the aspect of the integrated lens assembly is not limited to a flower pattern as disclosed in this embodiment; any other patterns can also be used according to user's preferences.

Since the lens protection device 21 can fully encapsulate the lens 20, the lens 20 is not limited to being located inside the casing 10. The lens 20 may be designed to protrude or hide from the exterior surface of the casing 10 to match with the aesthetics of the cell phone. For example, when the lens 20 is disposed to align flush with the casing 10, it has a flat aesthetic aspect on the casing 10, and, when the lens 20 is designed to protrude from the casing 10, it creates an embossed effect on the casing 10.

According to the invention, the lens needs not to be spaced apart and kept at distance from the lens protection device as done in the prior art. Instead, the lens protection device directly covers or encapsulates the lens. The lens can be designed to either protrude or not protrude from the casing. Reduction of the space between the lens and the lens protection device allows reduction of the overall thickness of the integrated lens assembly according to the invention.

Furthermore, the forward end of the lens can be flush with or protrude from the casing, such that the appearance such as color and shape of the lens protection device can correspond to the aesthetic design of the casing of the integrated lens assembly according to the invention.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

1. An integrated lens assembly, comprising:
a casing having an opening;
a lens having a forward end that is received in the opening of the casing;
a lens protection device embedded in the casing via the opening to encapsulate the forward end of the lens, wherein the lens protection device partially protrudes from the casing;
an image processing unit optically connected to the lens for electrically acquiring an image; and
a power source electrically connected to the image processing unit to supply power to the image processing unit for operating the image processing unit.

2. The integrated lens assembly of claim 1, wherein the forward end of the lens is flush with the casing.

3. The integrated lens assembly of claim 1, wherein the forward end of the lens protrudes from the casing by a predetermined length.

4. The integrated lens assembly of claim 1, wherein the color of the lens protection device corresponds to the aesthetic design of the casing.

5. The integrated lens assembly of claim 1, wherein the shape of the lens protection device corresponds to the aesthetic design of the casing.

6. The integrated lens assembly of claim 1, wherein the lens protection device is a lid structure in a U shape, allowing the forward end of the lens to be received in the U-shaped lid structure.

7. The integrated lens assembly of claim 1, wherein the integrated lens assembly is used in an electronic product selected from the group consisting of a cell phone, personal digital assistant (PDA), and notebook computer.
